(19) United States
(12) Patent Application Publication
(10) Pub. No.: US 2013/0060519 A1
(43) Pub. Date: Mar. 7, 2013

(54) ENCODER TO DETERMINE THE POSITION OF A PISTON IN A HYDRAULIC OR A PNEUMATIC CYLINDER

(71) Applicant: Jonas Hahne, Kowloon (HK)

(72) Inventor: Jonas Hahne, Kowloon (HK)

(73) Assignee: SCANDINAVIAN CONSTRUCTION COMP. A/S, Allerod (DK)

(21) Appl. No.: 13/696,283

(22) PCT Filed: May 5, 2011
(86) PCT No.: PCT/IB2011/051995

§ 371 Date: Nov. 5, 2012

(30) Foreign Application Priority Data
May 6, 2010 (DK) PA 2010 00397

(51) Int. Cl. G01B 7/30; G01B 11/14

(52) U.S. Cl. 702/151

(57) ABSTRACT

A method to determine a position of a piston reciprocating inside a hydraulic cylinder or a pneumatic cylinder between a first end position and a second end position, with the piston parting the cylinder in first and second chambers, and with at least one of the chambers at least partly filled with a fluid. The method includes the steps of driving a wheel structure of a hydraulic motor or a pneumatic motor by the force of the fluid led to or from the first or second chamber, driving a shaft encoder by the hydraulic motor or the pneumatic motor, measuring at least one parameter corresponding to a rotation or an angular displacement of the wheel structure using the shaft encoder, and calculating the position of the piston.

The present invention relates to a method to determine a position of a piston reciprocating inside a hydraulic cylinder or a pneumatic cylinder between a first end position and a second end position, the piston parts the hydraulic cylinder or the pneumatic cylinder in a first chamber and a second chamber, and at least one of the chambers is at least partly filled with a fluid.

Hydraulic systems are used in many different industries like e.g. building, construction, shipping, and mining. In many of the applications it is important to know the exact position of the piston in the hydraulic cylinder. As an example can be mentioned when goods are about to be taken down from a shelf or put onto a shelf by a forklift truck it is a big advantage to know the precise height of the forks. This is done e.g. by determining the actual position of the pistons in the hydraulic cylinders. In big storerooms unmanned forklift trucks or robots that fetch goods and put them in place on the shelves. The unmanned trucks or robots also need to know the height of the forks to be able to manoeuvre in relation to the shelves. Robots that use hydraulic cylinders always need to know the position of each of the pistons in the hydraulic cylinders.

Also when a crane loads cargo on e.g. a ship it is important to know the right position of the load so that the load is not smashed into the deck of the ship. Yet another example is pipe-handling machines on oilrigs, where a pipe handling machine operates and guides a pipe in the right position in relation to another pipe so that the pipes can be connected to each other.

In the prior art there are measurement constructions or sensors to determine the position of the piston, where the sensor is placed inside or built together with the hydraulic cylinder. One such sensor is the Absolute magnetostrictive linear position sensor. The sensor is situated at the bottom end of the cylindrical housing of a hydraulic cylinder. A bar is protruding into the hydraulic cylinder from the sensor and a magnet is movably positioned on the bar. The magnet is attached to the end of the piston rod facing the sensor. When the cylinder is in its contracted position the sensor is close to the magnetic ring and measures a high magnetic field, while in the extended position the magnetic field from the magnetic ring at the sensor is much weaker. If such a measurement construction breaks down the hydraulic cylinder has to be taken apart, which is not easy when the hydraulic cylinder weighs hundreds of kilograms, during a storm late in the autumn onboard a ship or on an oil drilling rig.

International patent application no. WO01/66954 suggests to place a flow restriction member in a conduit outside the hydraulic cylinder, where the conduit comprises a hydraulic pump for pumping the hydraulic fluid or the pneumatic fluid from the cap end to the rod end and vice versa. The difference in pressure between the two sides of the flow restriction member is measured and the flow velocity and direction is calculated. The flow restriction member limits the flow, though, and makes the flow heavier so that the hydraulic pump must work harder and use more fuel.

In a first aspect according to the present invention is provided a method to accurately determine the position of the piston in a hydraulic cylinder.

In a second aspect according to the present invention is provided a device to determine the position of the piston inside a hydraulic cylinder to be repaired, without demounting the hydraulic cylinder.

In a third aspect according to the present invention is provided a method to accurately determine the position of the piston in a hydraulic cylinder without loosing pressure over the flow gauge.

In the following the use of the term “motor” shall be understood to mean a hydraulic motor or a pneumatic motor, i.e.

a construction that transforms the flow of fluid to a rotation of the wheel structure and/or the shaft of the wheel structure.

The novel and unique whereby the above aspects can be met according to the present invention is a method that comprises the steps of (a) driving a wheel structure of a hydraulic motor or a pneumatic motor by the force of the fluid led to or from the first and/or second chamber, (b) driving a shaft encoder by the hydraulic motor or the pneumatic motor, (c) measuring at least one parameter corresponding to a rotation and/or an angular displacement of the wheel structure using the shaft encoder, and (d) calculating the position of the piston.

Although the steps of the method according to the present invention are indicated by the order (a), (b), (c) and (d), this indication should not be understood as limiting the scope of the present invention. The person skilled in the art will understand that the steps (a)-(d) can be performed in any arbitrary order.

The motor may be placed in a conduit guiding the fluid from or to any of the chambers. The motor may be driven by the flow of hydraulic fluid or pneumatic fluid. The flow of hydraulic fluid or pneumatic fluid may cause the wheel structure to rotate. The wheel structure can be a paddle wheel, a blade wheel, a bucket wheel, an impeller, propeller or a turbine. The common feature may be that the wheel structure has a shaft and blades like a straight and even plate, bowl or bucket protruding from the shaft. The blade can also be rotated or screwed like in a turbine or an impeller. Like an impeller, the wheel structure can also have a surrounding ring outside the blades. The motor can be just the wheel structure without any housing placed in the flow of fluid.

The sort of wheel may be chosen depending on whether low power consumption or size of the motor is the main concern. If power consumption has to be as low as possible a turbine, propeller or impeller is the best choice, since they have low drag or fluid resistance. If the motor has to be slim due to space restrictions a good solution can be to let the fluid enter the wheel perpendicular to a rotation axis of the wheel with an offset in relation to the rotation axis. For such considerations a bucket wheel or a paddle wheel would be the best choice. The bucket wheel or the paddle wheel is made with a large diameter in relation to the width of the wheel.

Using a paddle wheel or a blade wheel with many blades increases the accuracy of the determination of the fluid that is passing the wheel structure and also the position of the piston is determined with higher accuracy.

The advantage of using a wheel structure is that the resistance on the flow of fluid is low resulting in low losses and low extra consumption of electricity or fuel.

The rotation of the shaft of the motor may be transferred to a shaft of the shaft encoder. The motor and the shaft encoder can have a common shaft or the rotation is transferred by e.g. a gear wheel.

The shaft encoder can be an optical shaft encoder where a plate with holes near the outer edge rotates with the shaft of the shaft encoder. A lamp may illuminate the plate at the radii where the holes are. On the other side of the plate seen from the lamp a detector may be positioned to register the light from the lamp when a hole in the plate is in-between and to register no light from the lamp when a hole in the plate is not in-between. The plate may register the variation in light radiation when the shaft of the shaft encoder and the plate rotate. The information about a frequency of the variation in light from the lamp through the plate or the rotation and/or an angular displacement of the plate or shaft encoder may be processed in step (d) to calculate the position of the piston.

Another advantage of using a wheel structure is that the position of the piston can be determined with high accuracy.

In most cases a hydraulic pump pumps the fluid from the first chamber to the second chamber through the conduit. It is also possible that the fluid is pumped through the conduit out of or into one of the chambers only.

Preferably the method is modified in that step (b) is substituted by step (b′) measuring at least one parameter corresponding to a rotation and/or an angular displacement of the wheel structure using an optical or magnetic sensor, and step (c) is substituted by step (c′) sending a signal corresponding to the at least one parameter obtained in step (b′) the optical or magnetic sensor to a computer or a processor.

Like the steps (a)-(d), the steps (a), (b′), (c′) and (d), should not be understood as limiting the scope of the present invention. The person skilled in the art will understand that the steps (a), (b′), (c′) and (d), can be performed in any arbitrary order.

The rotation of the wheel structure can be measured directly by the optical or magnetic sensor. The housing comprising the wheel structure can have at least one window through which the optical sensor can register rotation e.g. by how the light from a light source is reflected by the blades. A magnetic sensor can register the rotation of the wheel structure if the blades are magnetic. The optical or magnetic sensor will send information or the at least one parameter corresponding to a rotation and/or an angular displacement of the wheel structure to a computer or a processor that will calculate the rotation of the wheel structure and the position of the hydraulic or pneumatic cylinder connected to the motor. Computer and processor should be understood to mean anything that is able to present information about the position of the hydraulic or pneumatic cylinder based on the information sent from the optical or magnetic sensor.

Advantageously the method may comprises repeating steps (c) and (d).

The measuring of the parameter corresponding to the rotation and/or the angular displacement of the wheel structure using the shaft encoder may be done continuously or discretely with or without a periodical interval. The measurements of the rotation and/or the angular displacement of the wheel structure may give the position of the wheel structure and how many rotations or fractions of one rotation the wheel structure has rotated since last calculation. Based on the rotation or fractions of one rotation the amount of fluid that has got past the wheel structure may be calculated and the position of the piston can also be calculated.

Preferably the calculation of the position of the piston may include at least one second parameter selected from the group comprising, leakage of the fluid in the hydraulic motor or the pneumatic motor as function of rotation speed of the wheel structure, temperature effects on the hydraulic motor or the pneumatic motor and on the fluid, and pressure effects on the fluid.

Fluid will always leak past the blades of the wheel structure. The leakage may vary depending on the rotation speed of the wheel structure, temperature and pressure of the fluid. When the position of the piston is calculated in step (d) the variation in leakage may be taken into consideration.

To reduce the resistance on the flow of fluid even more and reducing energy losses and the consumption of electricity or fuel, the fluid can be led through one or more parallel channels in excess of at least a first channel where the wheel structure is placed. The at least first channel may be parallel to the other channels. By comparing at different fluid pressures, velocities and/or viscosities the position and/or velocity of the piston the measured flow of the at least first channel can be calibrated to tell the total flow through all the channels including the leakage past the wheel structure. The flow through all the channels including the leakage past the wheel structure in the first channel can be taken into consideration in step (d) and the total true amount of passed fluid can be calculated.

In a preferred embodiment the method may further comprise step (e) of calibrating the hydraulic motor or the pneumatic motor, the piston and/or the encoder when the position is in any of the first end position or the second end position with or without a periodical interval.

Any fault in the interpretation of the rotation of the wheel structure in relation to the position of the piston can accumulate. To eliminate the risk of calculating the position of the piston totally wrong the system may be calibrated at at least one certain position, particularly an end position. The advantage of determining the position at the end position is that it is easy and cheap. When the piston is at the end position the piston may press and activate a mechanical switch. Another solution may be to use an active infrared sensor that emits an infrared beam that is reflected and the infrared sensor registers the reflection. When the piston breaks the beam the infrared sensor can tell that the piston has reached the end position. Instead of the infrared wavelength range another wavelength range like the visible may be used. The active infrared sensor is changed for a sensor that can emit and register the used wavelength or wavelengths.

The person skilled in the art will understand that the steps (a)-(e) can be performed in any arbitrary order.

In another embodiment of the method the leakage of the fluid in the hydraulic motor or the pneumatic motor, the temperature effects and the pressure effects can be recalculated at calibration step (e), preferably at each calibration step (e).

For each calibration the processor or computer may be able to calculate how big the difference is between the predicted and actual position of the piston and compensate for the difference in future calculations of the position of the piston inside the cylinder. A processor or computer with smart software may expediently be used for the calculations of the position of the piston, facilitating better and better results for the position for every calibration. Smart software might be recording the difference between the predicted and actual position of the piston at the calibration as well as the temperature and/or pressure of the fluid and the rotation of the wheel structure to provide a continuously, accurate updated record of the position of the piston inside the cylinder.

In another embodiment the method may comprise measuring the pressure of the fluid on both sides of the piston.

The fluid in a pneumatic system is compressible. To be able to calculate the position of the piston in a pneumatic system with a certain degree of accuracy not only the amount of the fluid—that has been removed and/or added to the first chamber and the second chamber since the piston was at the first end position or the second end position—has to be measured but it will be advantageous to also measure the pressure of the fluid on both sides of the piston. Also the temperature of the fluid on both sides of the piston can be measured.

The invention further relates to a device to determine a position of a piston reciprocating inside a hydraulic cylinder or a pneumatic cylinder, comprising the piston, parting the hydraulic cylinder or the pneumatic cylinder in a first chamber and a second chamber, a fluid, at least partly filling at least one of the first chamber and the second chamber, a hydraulic pump or pneumatic pump for pumping the fluid to at least one of the chambers via at least one conduit, where the device comprises a hydraulic motor or a pneumatic motor positioned in the at least one conduit, the hydraulic motor or the pneumatic motor comprises a wheel structure comprising a shaft with a plurality of circumferentially spaced apart protruding blades rotating about the shaft in response to the flow of the fluid through the at least one conduit, and transmitting a rotation and/or an angular displacement of the wheel structure to a shaft of a shaft encoder, and a processor or a computer that responds to at least one first parameter corresponding to the measured rotation and/or the measured angular displacement of the wheel structure from the shaft encoder and calculates the position of the piston.

Plurality shall be understood to mean two, three, four, five or more.

Although the points of the device according to the present invention are indicated by the order (i), (ii), (iii), (iv) and (v) this indication should not be understood as limiting the scope of the present invention. The person skilled in the art will understand that there is no time indication in the order of the points (i)-(v).

Computer and processor should be understood to mean anything that is able to present information about the position of the hydraulic or pneumatic cylinder based on the information sent from the optical or magnetic sensor.

The motor may have conduits that guide the fluid from or to any of the chambers. The motor can be driven by the flow of hydraulic fluid or pneumatic fluid, which causes the wheel structure to rotate. The wheel structure can be a paddle wheel, a blade wheel, a bucket wheel, an impeller, propeller or a turbine. The common feature is that the wheel structure has a shaft and blades like a straight and even plate, a bowl or a bucket protruding from the shaft. The blades can also be rotated or screwed like in a turbine, a propeller or an impeller. Like an impeller, the wheel structure can also have a surrounding ring outside the blades. The motor can be just the wheel structure placed in the flow of fluid.

The advantage of a wheel structure and especially a propeller, an impeller or a turbine is that the resistance on the flow of fluid is low resulting in low losses and low consumption of electricity or fuel. To further reduce the flow resistance the wheel structure can have a low friction coating or the material of the wheel structure may be made of a material, which surface means low friction for the fluid. The surface of the wheel structure and especially the blades may also have a structure that reduces fluid friction. The structure could be the shark structure used on professional swimming suits. The structure could also be like a surface with depressions as the surface of a golf ball.

The motor with the wheel structure can be made very slim, which is an advantage if the place, where the motor is situated, does restrict the size of the motor in one dimension. The slimness of the motor can be achieved by letting the fluid enter the wheel structure perpendicular to the rotation axis of the wheel structure and with an offset in relation to the rotation axis. For such considerations a bucket wheel or a paddle wheel would be the best choice.

Using a paddle wheel or a blade wheel with many blades increases the accuracy of the determination of the fluid that is passing the wheel structure and also the position of the piston is determined with higher accuracy.

The motor and the shaft encoder can have a common shaft that transfers the rotation from the motor to the shaft encoder. Another possibility may be that a shaft of the motor and a shaft of the shaft encoder have a common connection like e.g. a gear wheel.

The shaft encoder can be an optical shaft encoder having a disc or plate with holes near the outer edge of the disc. The disc or plate may rotate with the shaft of the shaft encoder. A lamp may illuminate the plate at the radii where the holes are. On the other side of the plate seen from the lamp a detector may be positioned to register the light from the lamp when a hole in the plate is in between and to register no light from the lamp when a hole in the plate is not in between. The plate may register the variation in light radiation when the shaft of the shaft encoder and the plate rotate and may send a parameter corresponding to a frequency of the variation in light from the lamp through the plate or the rotation and/or an angular displacement of the plate to the processor or the computer that may calculate the position of the piston based on the rotation, the angular displacement, the velocity and/or the direction of the shaft encoder.

If the fluid is pneumatic fluid the fluid is compressible. The response of the piston when fluid is pumped is then dependent on the load on the piston. For the processor or the computer to calculate the position of the piston it may be an advantage that the compressibility of the fluid for different pressures and temperatures is known to the processor or the computer. Also the pressure and/or the temperature in the first chamber and in the second chamber may be advantageously known to the processor or the computer.

There might be at least yet another conduit between the hydraulic pump or the pneumatic pump and any of the first chamber and the second chamber where the yet another conduit can be connected parallelly with the conduit where the wheel structure is. Since the fluid that may pass through the yet another conduit will not pass the wheel structure the fluid passing through the yet another conduit will experience less energy loss as the fluid passing the conduit where the wheel structure is. By letting most of the fluid pass the at least yet another conduit without wheel structure and only letting a small fraction of the total fluid pass the conduit where the wheel structure is, even more energy can be saved. It may be important that the ratio between the fluid that passes the conduit having the wheel structure and the fluid passing the at least yet another conduit without wheel structure is known. Advantageously, the processor or the computer may calculate the whole flow of fluid through the conduit and the at least yet another conduit based on the flow past the wheel structure through the conduit and determine the position of the piston.

In yet another embodiment the hydraulic motor or the pneumatic motor can be the hydraulic pump or the pneumatic pump, and the wheel structure can be a rotating member that cause the pumping in the hydraulic or pneumatic pump.

A shaft of the rotating member that cause the pumping in the hydraulic or the pneumatic pump may be connected to the shaft of the shaft encoder e.g. by a gear. The shaft encoder can be advantageously positioned outside the hydraulic or pneumatic pump for easy access if the shaft encoder breaks. To calculate the real flow caused by the hydraulic or pneumatic pump a temperature means and a pressure means can be advantageously used to measure the temperature and pressure close to the hydraulic or pneumatic pump. The processor or the computer may calculate the real flow and the position of the piston based on a signal from the shaft encoder and signals from the temperature means and the pressure means. The advantage is that since the wheel structure is the rotating member that cause the pumping in the hydraulic or the pneumatic pump the fluid flows with no friction or energy losses except for the friction or energy losses of the walls of the conduits and of the hydraulic or pneumatic pump and of the hydraulic or pneumatic cylinder.

In a preferred embodiment of the device according to the present invention, the processor or the computer may have or may be connected to a storage means where the viscosity at at least one temperature and at least one pressure of the hydraulic or pneumatic fluid may be stored and where the real flow of the hydraulic or pneumatic fluid at at least one pumping speed of the pump as well as at at least one temperature, at least one pressure and at least one viscosity of the fluid may be stored. The processor or the computer may calculate the real flow and the position of the piston based on a signal from the shaft encoder and signals from the temperature means and the pressure means as well as on the stored data.

If the wheel structure is placed in the conduit some of the fluid passing the wheel structure may cause the wheel structure to rotate and some of the fluid may leak past the wheel structure without contributing to the rotation of the wheel structure. The leakage of fluid past the wheel structure may depend on the pumping speed, the temperature, the pressure and the viscosity. Preferably the leakage of fluid past the wheel structure is stored on the storage means for at least one pumping speed, at least one temperature, at least one pressure and at least one viscosity of the fluid. The processor or the computer may calculate the real flow and the position of the piston based on a signal from the shaft encoder and signals from the temperature means and the pressure means as well as on the stored data including the leakage of fluid past the wheel structure.

Another advantage of the wheel structure may be that the position of the piston can be determined with high accuracy. The fluid may be hydraulic fluid or pneumatic fluid.

The hydraulic or pneumatic pump can be a hydraulic cogwheel pump.

In another embodiment the device is modified in that point (iv) is substituted by point (iv′) a wheel structure comprising a shaft with a plurality of circumferentially spaced apart protruding blades rotating about the shaft in response to the flow of the fluid through the conduit, and point (v) is substituted by point (v′) an optical or magnetic sensor measuring the rotation of the wheel structure and sending at least one first parameter corresponding to the measured rotation and/or the measured angular displacement of the wheel structure to a processor or a computer, and by point (v′) the processor or the computer calculating based on the at least one first parameter the position of the piston.

Like the points (i)-(v), the points (i), (ii), (iii), (iv′), (v′) and (vi′), should not be understood as limiting the scope of the present invention. The person skilled in the art will understand that there is no time indication in the points (i), (ii), (iii), (iv′), (v′) and (vi′).

The housing comprising the wheel structure can have at least one window through which the optical sensor can register rotation. The rotation can be registered e.g. by how the light from a light source is reflected by the blades. A magnetic sensor can register the rotation of the wheel structure if the blades of the wheel structure are magnetic. The housing can then comprise an area that is transparent to magnetic fields so that the magnetic variation due to the rotation of the wheel structure is transferred to outside the housing. That means that the rotation of the wheel structure can be measured directly on the wheel structure by the optical or magnetic sensor. The optical or magnetic sensor will send information or the at least one parameter corresponding to a rotation and/or an angular displacement of the wheel structure to a computer or a processor that will calculate the rotation of the wheel structure and the position of the hydraulic or pneumatic cylinder connected to the motor.

Advantageously the hydraulic motor or the pneumatic motor may further comprise, a housing inserted in the conduit, the housing may have a cavity accommodating the wheel structure.

The flow of fluid through the conduit from the first chamber or the second chamber may flow into the cavity and past the wheel structure. The cavity may have interior walls. The cavity and the blades of the wheel structure may be formed so that the blades and the interior walls of the cavity is in contact in at least most of the distance of one rotation.

Preferably the shaft of the wheel structure may be situated eccentric in the cavity of the housing.

If the wheel structure is situated in the centre of the cavity it is the flow of fluid that will rotate the wheel structure. But if the flow is low, the fluid and/or the fluid pressure will distribute evenly around the wheel structure and the wheel structure will stop rotating or the rotating will be heavy and the resistance on the flow of fluid will increase as well as energy losses and consumption of electricity or fuel.

If the wheel structure is situated eccentric in relation to the cavity the fluid will just pass around the wheel structure and the resistance on the flow of fluid will be low. Still the wheel structure will rotate due to the flow and the leakage may be compensated for.

In an embodiment of the device the wheel structure may have springs for applying a pressure force pressing the blades of the wheel structure against the interior walls of the cavity.

The pressure force pressing the blades of the wheel structure against the interior walls of the cavity may tighten the motor so that the leakage of fluid passing the wheel structure is decreased. Lower leakage means that the prediction about amount of fluid passing the motor is more exact as well as is the prediction about the position of the piston.

In another embodiment of the device, the device may comprise calibration means for calibrating the position of the piston.

Any fault in the interpretation of the rotation of the wheel structure in relation to the position of the piston can accumulate. To eliminate the risk of calculating the position of the piston totally wrong the device has calibration means at at least one certain position, particularly an end position. The advantage of determining the position at the end position is that the technology used can be very simple and cheap. The piston can e.g. press and activate a mechanical switch when the piston is at the end position. Another solution may be to use an active infrared sensor that emits an infrared beam that is reflected and the infrared sensor registers the reflection. When the piston breaks the beam the infrared sensor can tell that the piston has reached the end position.

In yet another embodiment of the device the calibration means may comprise a switch that transmits a signal to the processor or the computer when the piston is at an end position in the hydraulic cylinder or the pneumatic cylinder.

The calibration means can be in the form of a switch. When the calibration means is activated and the processor or the computer receives a signal the processor or the computer may know the position of the piston.

The device may comprise measuring means on both sides of the piston to measure the pressure of the fluid.

The fluid in a pneumatic system is compressible. To calculate the position of the piston in a pneumatic system with a certain degree of accuracy not only the amount of the fluid—that has been removed and/or added to the first chamber and the second chamber since the piston was at the first end position or the second end position—has to be measured but also the pressure of the fluid on both sides of the piston. Also means to measure the temperature of the fluid on both sides of the piston can be used.

The invention will be described by way of example below with reference to the drawing illustrating an exemplary embodiment of a wheel structure and an encoder to determine the position of a piston.

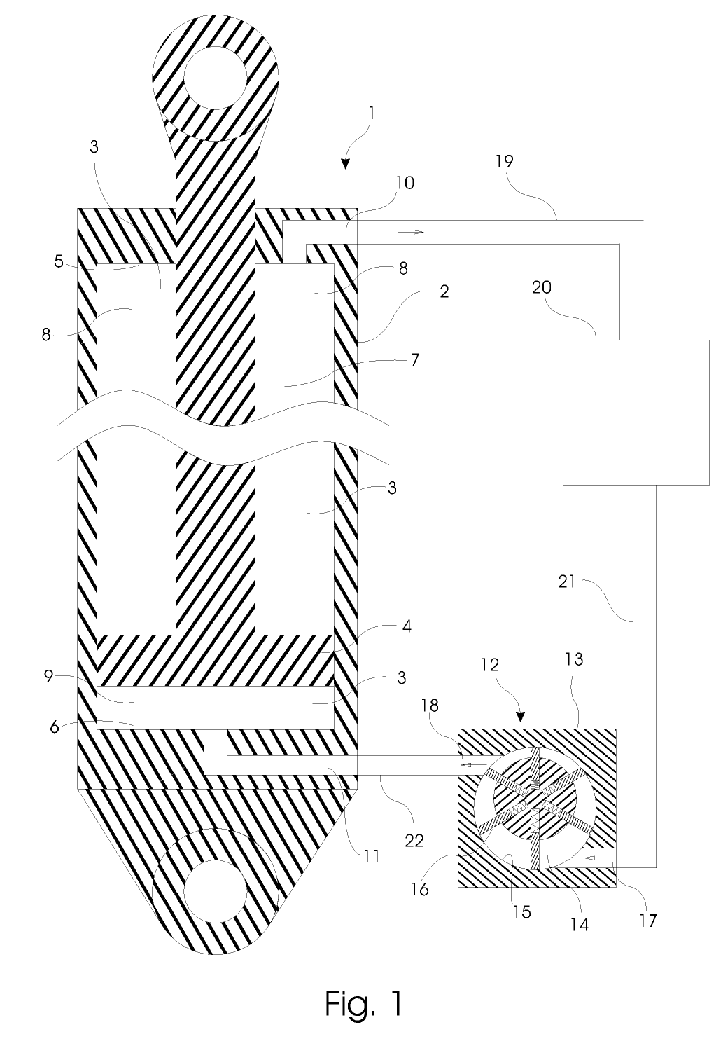

FIG. 1 shows in a schematically sectional view taken through a device connected to a hydraulic cylinder to determine the position of the piston inside a hydraulic cylinder,

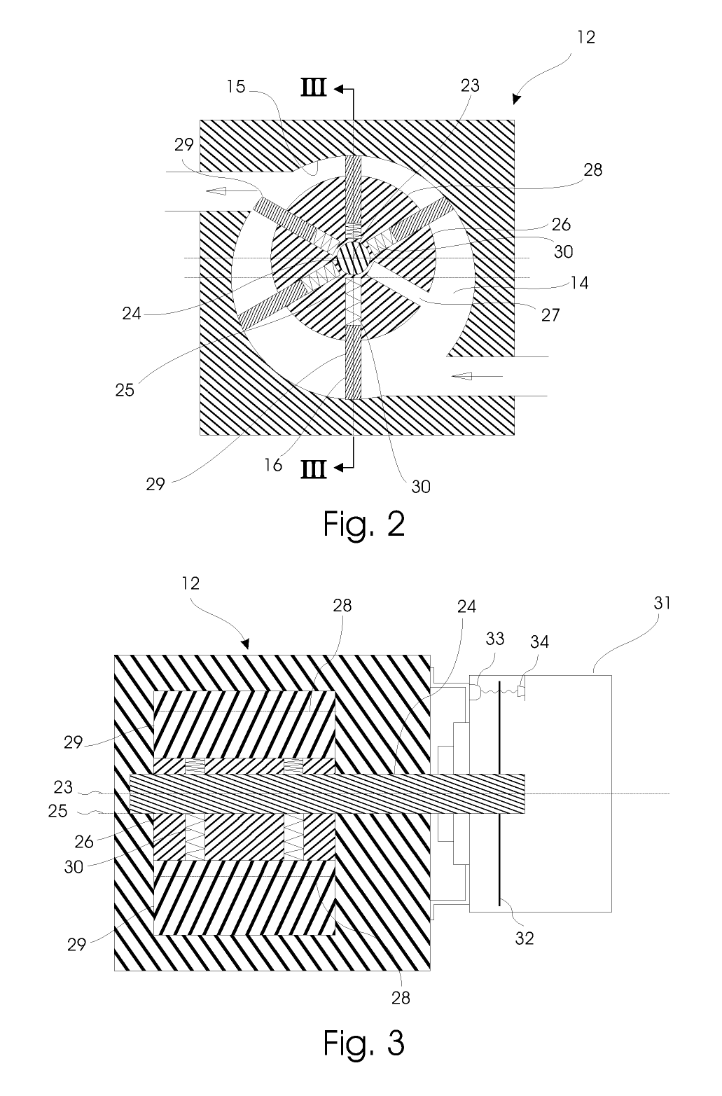

FIG. 2 shows in an enlarged scale the hydraulic motor of FIG. 1, and

FIG. 3 shows a sectional view of the enlarged hydraulic motor taken along line III-III in FIG. 2.

Within the scope of the present invention the exemplary embodiments should not be taken as limiting the scope of the present invention. Although the invention is described below for a hydraulic motor and a hydraulic cylinder the person skilled in the art will understand that the invention can be used in a pneumatic embodiment too.

According by way of example FIG. 1 illustrates a hydraulic cylinder 1 comprising a cylindrical housing 2 surrounding a cylindrical cavity 3 in which a piston 4 reciprocates between a first endpoint 5 and a second endpoint 6, pushing and pulling a connecting rod 7 outwards and inwards in relation to the cylindrical housing 2. The piston 4 divides the cylindrical cavity 3 into a first chamber 8 and a second chamber 9.

The first chamber 8 has a first opening 10 and the second chamber 9 has a second opening 11 through the cylindrical housing 2.

A hydraulic motor 12 comprises a housing 13 surrounding a cavity 14 with an interior wall 15. In the cavity 14 a wheel structure 16 can rotate. The housing has a third opening 17 and a fourth opening 18.

A first conduit 19 connects the first opening 10 of the first chamber 8 to a hydraulic pump 20 for pumping hydraulic fluid.

A second conduit 21 connects the pump 20 to the third opening 17 of the hydraulic motor 12 and the fourth opening 18 of the hydraulic motor 12 is connected to the second opening 11 of the second chamber 9 through a third conduit 22.

The pump 20 when pumping pumps fluid from the first chamber 8 through the first opening 10 and the conduit 19 to and through the pump 20 and further through the second conduit 21 and the third opening 17 to the hydraulic motor 12 and finally through the hydraulic motor 12, the fourth opening 18, the third conduit 22 and the second opening 11 to the second chamber 9 or vice versa. The pumping of the pump 20 creates a pressure difference between the first chamber and the second chamber that causes the piston 4 to move upwards or downwards.

The same volume of fluid that is pumped through the pump leaves the first chamber 8, passes the motor 12 and enters the second chamber 9 or vice versa. The piston 4 will move and sweep a volume corresponding to the fluid leaving/entering the first/second chambers and passing the motor 12. The revolutions of the wheel structure 16 in the motor will tell about size and direction of the displacement of the piston 4. If the start position of the piston is known also position after the displacement is known.

FIG. 2 is an enlarged scale view of the hydraulic motor 12 of FIG. 1. The hydraulic motor 12 comprises also a wheel structure 16 in the form of a blade wheel. The wheel structure 16 rotates inside the cavity 14 due to the flow of fluid through the hydraulic motor 12. The wheel structure 16 is situated eccentric in relation to the cavity 14. This means that a centre axis 23 of a shaft 24 of the wheel structure 16 is not the same as a centre axis 25 of the cavity 14. The wheel structure 16 comprises a centre hub 26 with grooves 27 extending more or less radially from a surface 28 of the hub 26 and inwards. In the grooves 27 blades 29 can freely move radially. In the shown embodiment the blades 29 are straight. In another embodiment the blades 29 may be bowl or bucket like or screwed like a blade on e.g. a turbine. The form of the grooves is fitted to the form of the blades 29 so that the movement of the blades 29 is not hindered. The blades 29 are biased by springs 30. The springs 30 press the blades 29 against the interior wall 15 of the cavity 14 to minimise leakage of fluid past the blades 29. In FIG. 2 one blade and one spring is removed to better show the grooves. The removal is due to illustrative reasons only.

In FIG. 3 the sectional view of the enlarged hydraulic motor 12 taken along line III-III in FIG. 2.

The shaft 24 of the wheel structure 16 is common with an optical shaft encoder 31.

An example of a preferred optical shaft encoder 31 is described in detail in European patent application no. EP 09173831.0. This known optical shaft encoder 31 comprises a disc 32 that rotates together with the shaft 24, as well as an emitter 33 that emits radiation (infrared, visible, ultraviolet or any other wavelength range). A detector 34 is situated on the other side of the disc 32 seen from the emitter 33, just opposite the emitter. The disc 32 has openings (not shown) at a radius where the radiation from the emitter 33 can pass one of the openings when one of the openings is in between the emitter 33 and the detector 34 and can then be registered by the detector. When no opening is in between the emitter 33 and the detector 34, the radiation is blocked and not registered by the detector.

The detector 34 sends electronic signals representing the variation in the registered radiation which also means the rotation of the shaft to a processor (not shown) or computer (not shown).

The processor or the computer calculates the position of the piston based on the rotation of the disc. The processor or the computer may also use viscosity, temperature and/or pressure of the fluid and/or the rotational speed of the disc when calculating the position of the piston.

The invention is not limited by the size of the cylinder or of the piston but the invention will be a good solution to determine the position of the piston of any size.

One advantage of using the wheel structure to determine the position of the piston is the low energy loss it causes. The accuracy of the position of the piston can easily be increased by using a larger disc 32. The distance between two neighbouring holes in the disc will correspond to a smaller angular displacement. Another possibility to increase the accuracy of the system is to use smaller openings in the disc and a shorter wavelength of the emitted radiation and maybe a narrower radiation beam, too. A third possibility to increase the accuracy is to decrease the size of the wheel structure 16 and the cavity 14 inside the motor 12. The wheel structure will then rotate more revolutions for the same amount of passing fluid.

If a low energy loss through the motor 12 is appreciated a larger wheel structure 16 and cavity 14 inside the motor is a solution.

The present invention is suitable for determining the position of the piston for any size if the piston.

1-15. (canceled)

16. A method to determine a position of a piston reciprocating inside a hydraulic or pneumatic cylinder between a first end position and a second end position, with the piston parting the cylinder in first and second chambers, and with at least one of the chambers at least partly filled with a fluid, which method comprises:
driving a wheel structure of a hydraulic or pneumatic motor by the force of the fluid led to or from the first or second chamber;
driving a shaft encoder by the motor;
measuring at least one parameter corresponding to rotation or angular displacement of the wheel structure using the shaft encoder; and
calculating the position of the piston based upon the at least one measured parameter.

17. The method according to claim 16, wherein the at least one parameter is measured using an optical or magnetic sensor, and which further comprises sending a signal corresponding to the at least one measured parameter to a computer or a processor.

18. The method according to claim 17, which further comprises repeating the driving and measuring or repeating the driving, measuring and sending as necessary to provide additional information.

19. The method according to claim 16, wherein the calculating of the position of the piston includes determining at least one second parameter corresponding to one or more of leakage of the fluid in the motor as a function of rotation speed of the wheel structure, temperature effects on the motor or fluid, and pressure effects on the fluid.

20. The method according to claim 16, which further comprises:
calibrating the motor, piston or shaft encoder when the position of the piston is at the first end position or the second end position with or without a periodical interval.

21. The method according to claim 20, which further comprises recalculating the leakage of the fluid in the motor, the temperature effects or the pressure effects after calibrating.

22. The method according to claim 16, which further comprises measuring the pressure of the fluid on both sides of the piston.

23. A device to determine a position of a piston reciprocating inside a hydraulic or pneumatic cylinder, comprising:
a piston parting the cylinder in a first or second chamber;
a fluid at least partly filling at least one of the first or second chambers;
a hydraulic or pneumatic pump for pumping the fluid to at least one of the chambers via at least one conduit;
a hydraulic or pneumatic motor positioned in the at least one conduit, the motor comprising:
a wheel structure comprising a shaft having a plurality of circumferentially spaced apart protruding blades rotating about the shaft in response to the flow of the fluid through the at least one conduit, and transmitting a rotation or an angular displacement of the wheel structure to a shaft of a shaft encoder, and
a processor or a computer that responds to at least one first parameter corresponding to the measured rotation and/or the measured angular displacement of the wheel structure from the shaft encoder and calculates the position of the piston.

24. The device according to claim 23, further comprising an optical or magnetic sensor measuring the rotation of the wheel structure and sending at least one first parameter corresponding to the measured rotation or angular displacement of the wheel structure to a processor or a computer, with the processor or computer calculating the position of the piston based on the at least one first parameter.

25. The device according to claim 23, wherein the motor further comprises a housing inserted in the conduit, the housing having a cavity accommodating the wheel structure.

26. The device according to claim 25, wherein the wheel structure is situated eccentrically in the cavity of the housing.

27. The device according to claim 23, wherein the circumferentially spaced apart protruding blades of the wheel structure are spring biased.

28. The device according to claim 23, further comprising calibration means for calibrating the position of the piston.

29. The device according to claim 28, wherein the calibration means comprises a switch that transmits a signal to the processor or the computer when the piston is at an end position in the cylinder.

30. The device according to claim 23, further comprising measuring means on both sides of the piston to measure the pressure of the fluid.
